(19) United States
(12) Patent Application Publication
(10) Pub. No.: US 2010/0247066 A1
(43) Pub. Date: Sep. 30, 2010

(54) METHOD AND APPARATUS FOR REVERSE PLAYBACK OF ENCODED MULTIMEDIA CONTENT

(75) Inventor: Shubham Baidyanath BHATTACHARYA, Bangalore (IN)

Correspondence Address: THE FARRELL LAW FIRM, LLP, 290 Broadhollow Road, Suite 210E, Melville, NY, 11747, US

(73) Assignee: Samsung Electronics Co., Ltd., Suwon-si (KR)

(21) Appl. No.: 12/750,020

(22) Filed: Mar. 30, 2010

(30) Foreign Application Priority Data
Mar. 30, 2009 (IN) 732/CHE/2009
Mar. 11, 2010 (KR) 10-2010-0021821

(51) Int. Cl. H04N 5/91

(52) U.S. Cl. 386/68

(57) ABSTRACT

Provided is a method for reverse playback of encoded multimedia content, including receiving a request for the reverse playback of the encoded multimedia content from a user or an electronic device, identifying a first Intra frame (I-frame) from a first Group Of Pictures (GOP) constituting a portion of the encoded multimedia content and preceding a last played frame at an instant of receiving the request, decoding first successive frames in the first GOP starting from the first I-frame, storing the first decoded frames in a memory, and playing the first decoded frames in a frame sequence effecting the reverse playback.

### PRIORITY

This application claims priority under 35 U.S.C. §119(a) to an application filed in the Indian Patent Office on Mar. 30, 2009 and assigned Serial No. 732/CHE/2009, and to a Korean Patent Application filed in the Korean Intellectual Property Office on Mar. 11, 2010 and assigned Serial No. 10-2010-0021821, the contents of both of which are incorporated herein by reference.

### BACKGROUND OF THE INVENTION

1. Field of the Invention

The present invention relates generally to the field of multimedia communication, and more particularly, to a method and an apparatus for reverse playback of encoded multimedia content.

2. Description of the Related Art

In the conventional operation, playback of encoded multimedia content in a media player can be manipulated by using capabilities such as forward, skip, rewind, and playback. The playback allows a user to view the encoded multimedia content in a forward and reverse motion sequence. A desired number of frames of the encoded multimedia content are decoded in succession for the played back content. However, the decoding of the frames for the reverse playback is problematic due to the sequential nature of bit streaming in the multimedia content, and the iterative decoding of multiple frames in order to enable the reverse playback. This iterative decoding results in an increased processing and computational time required for enabling the reverse playback. Further, the decoded frames may need to be continuously stored in memory, resulting in a waste of memory space.

Accordingly, there is a need for a method and apparatus for effective reverse playback of encoded multimedia content.

### SUMMARY OF THE INVENTION

An aspect of the present invention is to address at least the above-mentioned problems and/or disadvantages and to provide at least the advantages described below. Accordingly, an aspect of the present invention provides a method and apparatus for effective reverse playback of encoded multimedia content.

In accordance with an aspect of the present invention, there is provided a method for reverse playback of encoded multimedia content, the method including receiving a request for the reverse playback of the encoded multimedia content from a user or an electronic device, identifying a first Intra frame (I-frame) from a first Group Of Pictures (GOP) constituting a portion of the encoded multimedia content and preceding a last played frame at an instant of receiving the request, decoding first successive frames in the first GOP starting from the first I-frame, storing the first decoded frames in a memory, and playing the first decoded frames in a frame sequence effecting the reverse playback.

In accordance with another aspect of the present invention, there is provided an apparatus for reverse playback of encoded multimedia content, the apparatus including a processor for identifying a first intra frame (I-frame) preceding a last played frame from a first group of pictures (GOP) constituting a first portion of the encoded multimedia content, at an instant of receiving a request for the reverse playback from a user or an electronic device, decode first successive frames in the first GOP starting from the first I-frame, and play the first decoded frames in a frame sequence effecting the reverse playback, and a memory for storing the first decoded frames.

In accordance with another aspect of the present invention, there is provided a computer readable medium storing a program causing a processor to execute a process for data processing, the process including receiving a request for reverse playback of encoded multimedia content from a user or an electronic device, identifying a first intra frame (I-frame) from a first group of pictures (GOP) preceding a last played frame at instant of receiving the request, wherein the first GOP constitute a portion of the encoded multimedia content, decoding first successive frames in the first GOP starting from the first I-frame, storing the first decoded frames in a memory, and playing the first decoded frames in a frame sequence effecting the reverse playback.

### BRIEF DESCRIPTION OF THE DRAWINGS

The above and other aspects, features and advantages of embodiments of the present invention will be more apparent from the following description taken in conjunction with the accompanying drawings, in which:

FIG. 1 illustrates an environment, in accordance with which various embodiments of the present invention can be implemented;

FIG. 2 illustrates an electronic device in accordance with an embodiment of the present invention;

FIG. 3 is a block diagram of a server in accordance with an embodiment of the present invention; and

FIG. 4 and FIG. 5 are a flowchart illustrating a method for reverse playback of encoded multimedia content, in accordance with an embodiment of the present invention.

Persons skilled in the art will appreciate that elements in the figures are illustrated for simplicity and clarity and may have not been drawn to scale. For example, the dimensions of some of the elements in the figures may be exaggerated relative to other elements to help to improve understanding of various embodiments of the present disclosure.

### DETAILED DESCRIPTION OF EMBODIMENTS

The following description with reference to the accompanying drawings is provided to assist in a comprehensive understanding of embodiments of the invention as defined by the claims and their equivalents. It includes various specific details to assist in that understanding but these are to be regarded as mere examples. Accordingly, those of ordinary skill in the art will recognize that various changes and modifications of the embodiments described herein can be made without departing from the scope and spirit of the invention. In addition, descriptions of well-known functions and constructions are omitted for the sake of clarity and conciseness.

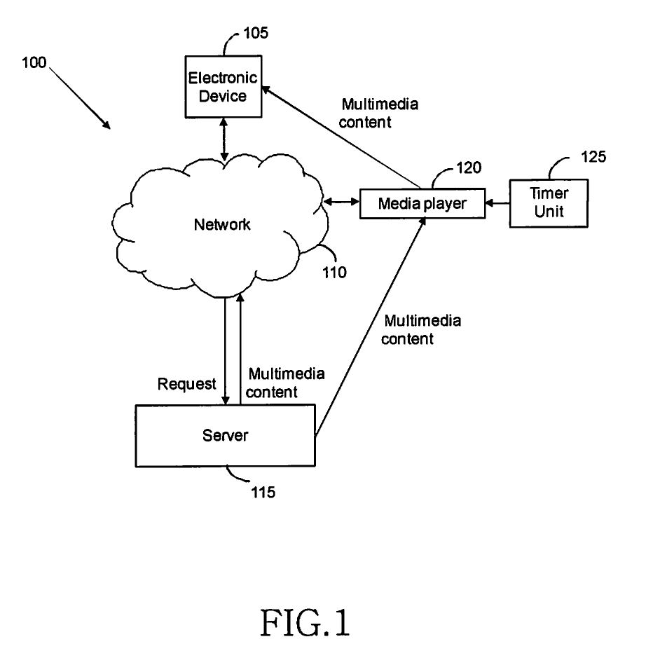

FIG. 1 illustrates an environment 100, in accordance with which various embodiments of the present invention can be implemented.

The environment 100 includes an electronic device 105 connected to a network 110. Examples of the electronic device 105 include, but are not limited to computers, laptops, mobile devices, handheld devices, Internet protocol televisions, portable media players and Personal Digital Assistants (PDAs). Examples of the network 110 include, but are not limited to a Local Area Network (LAN), a Wireless Local Area Network (WLAN), a Wide Area Network (WAN), the Internet and a Small Area Network (SAN). The electronic device 105 is also connected to a server 115 through the network 110.

The electronic device 105 is connected to a media player 120 directly or via the network 110. The media player 120 is used for playback and display of the encoded multimedia content on the electronic device 105. For example, the media player 120 provides a Graphical User Interface (GUI) for playback of encoded multimedia content. Examples of the media player 120 connected to the electronic device 105 via the network 110 include those well known in the art, such as a YouTube player, an iTunes player, a MP3 player and a Bearshare player. Further, the media player 120 is in synchronization with a timer unit 125 that is used for playing the encoded multimedia content for a time interval. The encoded multimedia content includes, but is not limited to, at least one of text, audio, still images, animation, video, interactive content forms, and a combination thereof.

The encoded multimedia content is composed of multiple GOPs. The GOP is a section including some or all of frames classified as I-Frame representing a fixed image, Predictive Frame (P-Frame) having motion-compensated difference information from the preceding I- or P-frame, Bi-directionally predictive coded picture (B-Frame) having difference information from the preceding and following I- or P-frame and Direct Coded (DC) picture (D-frame) serving fast advance (i.e. fast previews of the encoded multimedia content). Each GOP begins with a single I-frame, and one or more P-frames, D-frames and B-frames follow the I-frame.

The electronic device 105 may receive a request for reverse playback via the media player 120 at a particular instant of playing the multimedia content. Playback speed for the reverse playback of the encoded multimedia content may also be specified in the request. The electronic device 105 decodes one or more frames from a first GOP constituting a portion of the multimedia content. The decoded frames are then stored in the electronic device 105 successively and are played in a frame sequence (i.e. the frame sequence inverse to a frame sequence for forward playback) effecting the reverse playback at the specific playback speed for a time interval. During the playing, one or more frames of a second GOP of the multimedia content are decoded simultaneously.

In one embodiment, the request for reverse playback can be sent to the server 115 through the network 110. The server 115 receives the request and decodes one or more frames of the multimedia content. The frames are successively stored upon decoding, and are re-encoded and transmitted to the electronic device 105 through the network 110 for a time interval effecting the reverse playback. The server 115 may transmit the encoded multimedia content to the electronic device 105 through the network 110 or the media player 120.

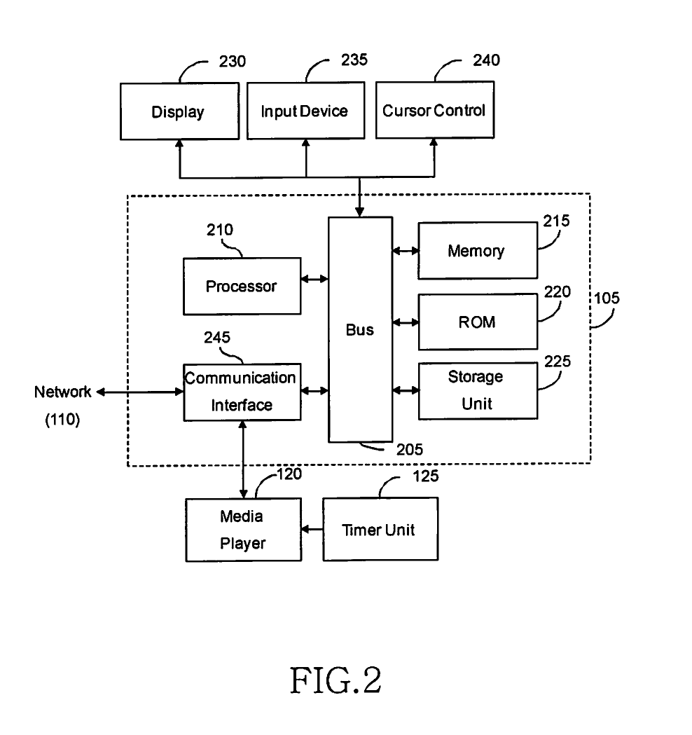

The electronic device 105 includes a plurality of elements for reverse playback of multimedia content. The electronic device 105 including the elements is explained in detail with respect to FIG. 2.

FIG. 2 illustrates the electronic device 105, in accordance with an embodiment of the present invention. The electronic device 105 includes a bus 205 for communicating information, and a processor 210 coupled with the bus 205 for processing information. The electronic device 105 also includes a memory 215 such as a Random Access Memory (RAM), coupled to the bus 205 for storing information required by the processor 210. The memory 215 can be used for storing temporary information required by the processor 210. The electronic device 105 further includes a Read Only Memory (ROM) 220 coupled to the bus 205 for storing static information required by the processor 210. A storage unit 225, such as a magnetic disk, hard disk or optical disk, can be provided and coupled to the bus 205 for storing information.

The electronic device 105 can be coupled via the bus 205 to a display 230, such as a Cathode Ray Tube (CRT) or Liquid Crystal Display (LCD), for displaying information. An input device 235, including various keys, is coupled to the bus 205 for communicating information to the processor 210. In some embodiments, a cursor control 240 such as a mouse, a trackball, a joystick, or cursor direction keys for communicating information to the processor 210 and for controlling cursor movement on the display 230 can also be present. The display 230, input device and cursor control can be included in the electronic device 105.

In one embodiment, the present invention is performed by use of the electronic device 105 in conjunction with the processor 210. The information can be read into the memory 215 from a machine-readable medium, such as the storage unit 225. In alternative embodiments, hard-wired circuitry can be used in place of or in combination with software instructions.

The term machine-readable medium is defined as a medium providing data to a machine to enable the machine to perform a specific function. The machine-readable medium can be a storage media. Storage media can include non-volatile media and volatile media. The storage unit 225 can be a non-volatile media. The memory 215 can be a volatile media. All such media must be tangible to enable the instructions carried by the media to be detected by a physical mechanism that reads the instructions into the machine.

Examples of the machine readable medium include, but are not limited to, a floppy disk, a flexible disk, hard disk, magnetic tape, a CD-ROM, optical disk, punchcards, papertape, a RAM, a Programmable Read Only Memory (PROM), an Electronically Programmable Read Only Memory (EPROM), and a FLASH-EPROM.

The machine-readable medium can also include online links, download links, and installation links providing the information to the processor 210.

The electronic device 105 also includes a communication interface 245 coupled to the bus 205 for enabling data communication. Examples of the communication interface 245 include, but are not limited to, an Integrated Services Digital Network (ISDN) card, a modem, a Local Area Network (LAN) card, an infrared port, a Bluetooth® port, a Zigbee® port, and a wireless port. A media player 120 is coupled to the communication interface 245 for playing decoded frames in a frame sequence effecting the reverse playback. The media player 120 is in synchronization with a timer unit 125, for playing the decoded frames for a time interval.

In some embodiments, the electronic device 105 can include the media player 120, which can be coupled directly to the bus 205. The media player 120 and timer unit 125 can be implemented with software programs or function modules that are stored in the storage unit 225 and performed by the processor 210.

The electronic device 105 can receive a request for reverse playback of an encoded multimedia content from a user through the input device 235. The multimedia content is stored in the memory 215. Further, the request is sent to the processor 210 to initiate the reverse playback. When receiving the request, the processor 210 identifies a first I-frame preceding a last played frame from a first GOP. The first GOP constitutes a first portion of the encoded multimedia content. The processor 210 then decodes the one or more first successive frames in the first GOP starting from the first I-frame sequentially and the one or more first decoded frames are stored in the memory 215, which is a circular queue having a sequence of slots for storing information. A single slot of the circular queue stores one decoded frame. The one or more first decoded frames are played by the media player 120 in a frame sequence effecting the reverse playback. Further, the playing is performed for a time interval managed by the timer unit 125.

During the process of playing the first decoded frames, the processor 210 identifies a second I-frame from a second GOP simultaneously. The second GOP precedes the first GOP and constitutes the second portion of the encoded multimedia content. Further, one or more second successive frames are decoded from the second GOP, which sequentially includes, from the second I-frame up to a preceding frame just before the first I-Frame, the one or more second successive frames. The second decoded frames are stored in succession corresponding to the decoding and are played in a frame sequence effecting the reverse playback and at a time interval which is based on the playback speed specified in the request.

In one embodiment, the first decoded frames and second decoded frames are re-encoded and transmitted in a frame sequence through the network 110 by the processor 210.

In some embodiments, the processor 210 can include one or more processing units such as a decoder and an encoder for performing one or more functions of the processor 210. The processing units are hardware circuitry performing specified functions.

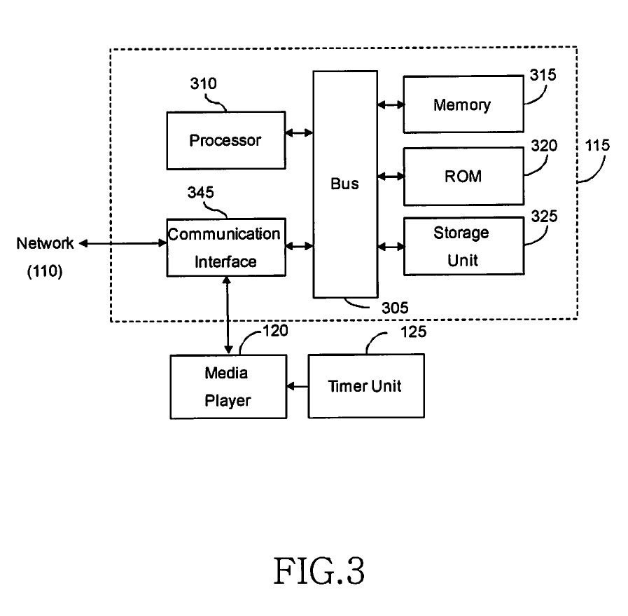

FIG. 3 illustrates the server 115, in accordance with an embodiment of the present invention. The server 115 includes a bus 305 for communicating information, and a processor 310 coupled with the bus 305 for processing information. The server 115 also includes a memory 315, such as a RAM, coupled to the bus 205 for storing information required by the processor 310. The memory 315 can be used for storing temporary information required by the processor 310. The server 115 further includes a ROM 320 coupled to the bus 305 for storing static information required by the processor 310. A storage unit 325, such as a magnetic disk, hard disk or optical disk, can be provided and coupled to bus 305 for storing information.

In one embodiment, the present invention is performed by use of the server 115 in conjunction with the processor 310. The information can be read into the memory 315 from a machine-readable medium, such as the storage unit 325. In alternative embodiments, hard-wired circuitry can be used in place of or in combination with software instructions to implement various embodiments.

The server storage unit 325 can be a non-volatile media, While memory 315 can be a volatile media.

The machine-readable medium can also include online links, download links, and installation links providing the information to the processor 310.

The server 115 also includes a communication interface 345 coupled to the bus 305 for enabling data communication. Examples of the communication interface 345 include, but are not limited to, an ISDN card, a modem, a LAN card, an infrared port, a Bluetooth® port, a Zigbee® port, and a wireless port. A media player 120 is coupled to the communication interface 345 for playing decoded frames in a frame sequence effecting the reverse playback. The media player 120 is in synchronization with a timer unit 125, for playing the decoded frames for a time interval.

The server 115 can receive a request for reverse playback of an encoded multimedia content through the communication interface 345. The multimedia content is stored in the memory 315. The request is sent to the processor 310 to initiate the reverse playback. When receiving the request, the processor 310 identifies a first I-frame preceding a last played frame from a first GOP. The first GOP constitutes a first portion of the encoded multimedia content. The processor 310 then decodes the one or more first successive frames in the first GOP starting from the first I-frame sequentially and the one or more first decoded frames are stored in the memory 315, which is a circular queue that includes a sequence of slots for storing information. A single slot of the circular queue stores one decoded frame. The first decoded frames are re-encoded and encapsulated in a buffer, which is used for transmitting the first decoded frames to the electronic device 105 through the network 110. The transmitting is performed in a frame sequence for a time interval managed by the timer unit 125.

During the process of transmitting the first decoded frames, the processor 310 identifies a second I-frame from a second GOP simultaneously. The second GOP precedes the first GOP and constitutes a second portion of the encoded content. Further, one or more second successive frames are decoded from the second GOP. The second GOP sequentially includes, from the second I-frame up to a preceding frame just before the first I-frame, the one or more second successive frames. The one or more second decoded frames are stored in succession corresponding to the decoding. The first decoded frames are re-encoded and encapsulated in the buffer. The buffer is used for transmission of the second decoded frames in succession to an electronic device through the network 110. Further, the transmitting is performed in a frame sequence for a predefined time interval managed by the timer unit 125.

In some embodiments, the processor 310 can include one or more processing units such as a decoder and an encoder for performing one or more functions of the processor 310. The processing units are hardware circuitry performing specified functions.

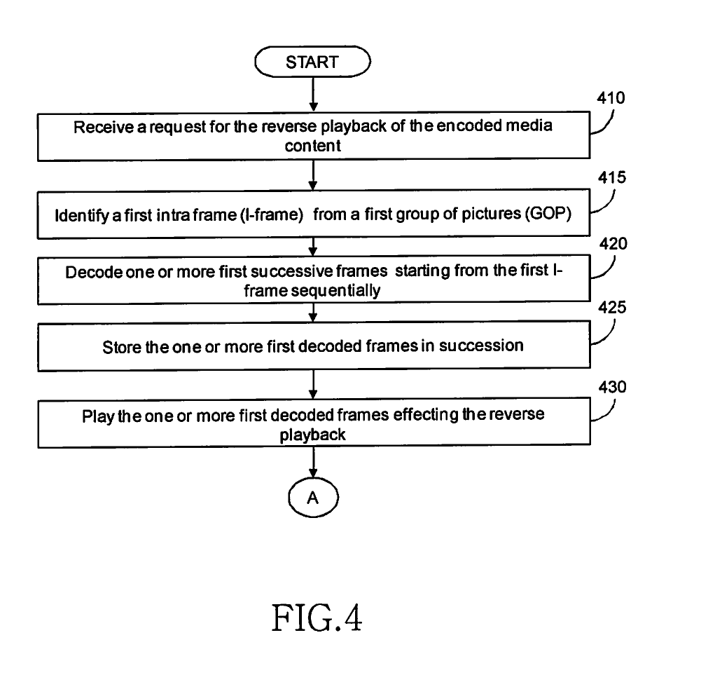

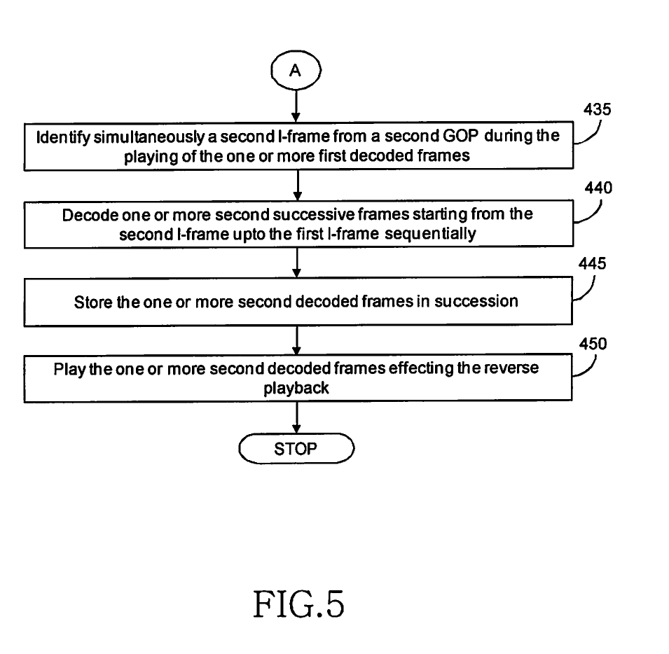

FIG. 4 and FIG. 5 are a flowchart illustrating a method for reverse playback of encoded multimedia content, in accordance with an embodiment of the present invention.

Playback of the encoded multimedia content stored in the electronic device 105 is initiated.

In some embodiments, playback of the multimedia content can be streamed from the server 115 to the electronic device 105 via the network 110.

At step 410, a request for reverse playback of an encoded multimedia content is received. The encoded multimedia content can be in one or more multimedia file formats. Examples of the multimedia file formats include, but are not limited to, MPEG-1, MPEG-2, MPEG-4, M-JPEG; Ogg, H.261, H.263, H.264, Divx, quicktime, flv, and Theora. The encoded multimedia content includes multiple GOPs. Each GOP begins with a single I-frame. One or more Predictive Frame (P-frames) and bi-directionally predictive coded picture (B-frames) follow the I-frame.

The request can include, but is not limited to, desired playback speed for the reverse playback. The desired playback speed can correspond to multiples of playback speed, for example, 1×, 2×, 3× and 4×, where “x” defines speed at which the multimedia content is played. Higher multiples of “x” increases the playback speed.

At step 415, a first I-frame from a first GOP preceding a last played frame at instant of receiving the request is identified.

The last played frame at the instant of receiving the request can be one of an I-frame and P-frame of the first GOP, which constitutes a portion of the encoded multimedia content.

At step 420, one or more first successive frames in the first GOP starting from the first I-frame are decoded sequentially.

The first successive frames can correspond to the P-frames subsequent to the first I-frame identified.

The number of the first successive frames to be decoded in the first GOP is computed based on at least one of available memory, frame rate for playback, playback speed, the number of frames to be displayed, and a ratio of the number of frames in the first GOP to the playback speed. For example, if 30 memory slots are available numbered from 0 to 29 and a GOP includes 15 frames, then the 15 frames can be decoded. If the GOP includes 40 frames, then only 30 frames can be decoded by alternate selection. For example, some frames among the 40 frames periodically disposed at regular intervals (e.g., every second frame) can be selected. In one embodiment, the last 10 frames in the GOP can be ignored for decoding.

Further, in another example, if the frame rate for displaying frames is 15 per second and there are 15 memory slots available to store the decoded frames, then every second, 15 frames can be decoded. If there are 30 frames are to be decoded, then the first 15 frames are decoded at an instant. The decoding of the next 15 frames is suspended until a few or all of the first 15 frames have been displayed.

A frame controller positioned at the last played frame, is repositioned to the first I-frame, which is fetched for decoding. The frame controller shifts to a next successive frame for decoding, which ends when the frame controller reaches the last played frame.

At step 425, the one or more first decoded frames are stored in succession corresponding to the decoding. The one or more first decoded frames correspond to the frames of the first GOP.

A circular queue can be used for storing the frames upon decoding. The circular queue is a data structure used for storage of information, and includes slots associated with indexes. A single slot stores one decoded frame. The slots depend on the size of the circular queue. For example, a circular queue of size 15 can include 15 slots. Further, the circular queue includes a buffer index pointing to last slot in the circular queue.

The one or more first successively decoded frames are stored in the circular queue.

In an embodiment of the present invention, the starting slot in the circular queue, for storing the one or more successively decoded frames, is determined. The buffer index is first moved X slots back from the last available slot in the circular queue based on number of the first successive frames in the first GOP. For example, if slots from 0 to 29 are available and the first GOP includes 15 frames, then the buffer index is moved back 15 slots from the slot 29. The decoded I-frame of the first GOP is stored at the slot 15. Further, the buffer index is moved forward to slot 16 and subsequently the successive decoded P-frames are stored in sequence till the end of the successive frames of the first GOP.

A time stamp may be associated with each of the first successively decoded frames during storage in the circular queue. Further, slots of the circular queue may be identified by a tag or metadata indicating availability of memory slots. For example, a memory slot may be tagged as being “in use” to indicate that data is stored in the memory slot and is being utilized.

Further, the one or more first successively decoded frames may be stored in original size or in compressed form for improved memory utilization. In addition, the one or more first successively decoded frames can be stored either in indexed or sequential arrangement in the circular queue.

In one embodiment, information related to the first decoded frames can also be stored sequentially. The information includes, but is not limited to the timestamp and post processing features. The post processing features can be applied to the first decoded frames selectively during playing. Examples of the post processing features include, but are not limited to contrast, color, and black and white display.

At step 430, the one or more first decoded frames are played in a frame sequence effecting the reverse playback. Each of the first decoded frames can be played for a time interval or frame rate based on playback speed specified in the request.

The first decoded frames are played from the circular queue using the corresponding timestamps.

A flag bit or a timer may be used to indicate the electronic device 105 to start displaying the decoded frames for a time interval.

Further, slots of the circular queue may be identified by the tag or the metadata indicating that memory slots are unavailable. For example, a memory slot may be tagged as being “not in use” to indicate that the memory slot is available for storing data.

In an embodiment, the display is initiated periodically depending on the desired speed of reverse playback. For example, if decoded frames 1 to 15 are stored in slots 15 to 29 in memory, then the frame sequence for effecting the reverse playback starts from 29 to 15. Accordingly, the decoded frame stored in slot 29 is displayed first, followed by decoded frames stored in memory slots up to 15.

At step 435, a second I-frame from a second GOP preceding the first I-frame and the first GOP is simultaneously identified during the playing of the one or more first decoded frames. The second GOP constitutes another portion of the encoded multimedia content preceding the first GOP.

At step 440, one or more second successive frames in the second GOP starting from the second I-frame up to the first I-frame sequentially are decoded.

In the embodiment, upon identifying the second I-frame, the number of frames present in the second GOP is computed.

The number of the second successive frames to be decoded in the second GOP is computed based on at least one of the available memory, the frame rate for playback, the playback speed, the number of frames to be displayed, and the ratio of the number of frames in the first GOP to the playback speed.

For example, If 25 memory slots are available from 0 to 24 and there are 15 frames in the first GOP and 15 frames in second GOP, then the 15 frames of the first GOP and 10 frames of the second GOP can be decoded. The remaining 5 frames of the second GOP can be decoded by alternate selection or the 5 frames can be ignored for decoding.

Further, in another example, if the frame rate for displaying frames is 15 per second and there are 15 memory slots available to store the decoded frames, then 15 frames can be decoded. If there are 15 frames from the first GOP and 15 frames from the second GOP that are to be decoded, then the first 15 frames are decoded at an instant. The decoding of the next 15 frames is suspended until a few or all of the first 15 frames have been displayed.

The frame controller is repositioned to the second I-frame and the second I-frame is fetched for decoding. Further, as each of the second successive frames is decoded the frame controller is shifted to a next second successive frame. The one or more second successive frames in the second GOP is decoded simultaneously while the one or more first decoded frames are displayed in reverse playback.

The one or more second successive frames can be decoded by at least one of, selecting alternatively amongst the one or more second successive frames in the second GOP for the decoding, and ignoring one or more successive frames among the one or more successive frames in the second GOP.

In some embodiments, the decoding process of the one or more second successive frames may be suspended until a threshold number of the one or more first successive frames is displayed. If the first decoded frames stored in memory slots are not being displayed or displayed at slow playback rate then, it may be suspended until the threshold.

At step 445, the one or more second decoded frames are stored in succession corresponding to the decoding depending on the playing of the first decoded frames.

The one or more second decoded frames are stored in the circular queue based on the availability of the circular buffer queue. In some embodiments, the storing of the one or more second decoded frames may be suspended until a threshold number of the first decoded frames are played.

At step 450, the one or more second decoded frames are played consequent to the playing of the first decoded frames in the frame sequence for a time interval effecting the reverse playback.

Each of the second decoded frames can be played for a time interval or frame rate based on playback speed specified in the request.

The second decoded frames are played from the circular queue using the corresponding timestamps.

The flag bit or a timer may be used to indicate the electronic device 105 to start the displaying.

In this embodiment, the display is initiated periodically depending on the desired speed of reverse playback. For example, if the first decoded frames 1 to 15 are stored in slots 15 to 29 in memory and the second decoded frames 16 to 30 are stored in slots 0 to 14 in the memory, then the frame sequence for effecting the reverse playback starts from 29 to 15. Accordingly, the decoded frame stored in slot 29 is displayed first, followed by decoded frames stored in memory slots up to 15. Consequently, the decoded frame stored in slot 14 is displayed first, followed by decoded frames stored in memory slots up to 0.

### EXAMPLE 1

Playback of the media content is initiated. Consider a played multimedia content including of three GOPs. The circular buffer queue includes six addresses denoted from address ‘0’ to ‘5’. Each GOP includes one I-frame and three P-frames. In this example, a total number of frames in a GOP less than a size of the circular buffer queue.

If a request for reverse playback of the encoded multimedia content is received at an instance of playing the 11th frame in the sequence of GOPs. The GOPs are GOP ‘A’, GOP ‘B’ and GOP ‘C’ are being played in sequence. If each GOP includes 4 frames, then with respect to the 11th frame, one I-frame and three P-frames from each of GOP ‘A’ and GOP ‘B’ and one I-frame and two P-frames from GOP ‘C’ have been played when receiving the request. The first I-frame preceding the 11th frame from the GOPs is identified from the GOP ‘C’. The I-frame and the successive P-frame are decoded sequentially. Upon decoding the I-frame, the index pointing to the last location is moved back by 3 addresses from the present address to address ‘3’. The I-frame is stored at address ‘3’.

Upon decoding the successive I-frames, the address is moved forward, and the P-frames are stored at address ‘4’ to address ‘5’ and the addresses from ‘3’ to ‘5’ are marked as in use. The flag is set indicating the availability of the GOP ‘C’ for display. The decoded GOP ‘C’ upon being stored is displayed in the reverse playback. Further, as each frame of the GOP ‘C’ is displayed, and the address corresponding to each frame is marked as “not in use”.

Simultaneously, the I-frame from the GOP ‘B’ preceding the I-frame of the first GOP is simultaneously identified during the playing of the GOP ‘C’. For storing the I-frame, the buffer index is moved back four addresses to address ‘2’ of the circular buffer queue. Consequently, successive P-frames of the GOP ‘B’ are decoded and stored in sequential memory from address ‘3’ to address ‘5’.

### EXAMPLE 2

Playback of the media content is initiated. Consider a multimedia content of three GOPs. The circular buffer queue includes six addresses denoted from addresses ‘0’ to ‘5’. Each GOP includes one I-frame and eight P-frames. In this example, a total number of frames in a GOP greater than a size of the circular queue.

If a request for reverse playback of the encoded multimedia content is received at an instance of playing the 26th frame in the sequence of GOPs, the GOPs are GOP ‘A’, GOP ‘B’ and GOP ‘C’ are being played in sequence. If each GOP includes 9 frames, then with respect to the 26th frame, one I-frame and eight P-frames from each of GOP ‘A’ and GOP ‘B’ and one I-frame and seven P-frames from GOP ‘C’ have been played when receiving the request. The first I-frame preceding the 26th frame from the group of pictures is identified. The I-frame and the successive P-frame are decoded sequentially. Upon decoding the I-frame, the index pointing to the last location is moved back by five addresses from the present address. Since the memory size is less than the number of frames in the GOP ‘C’, every second P-frame may be used, for example frames 19, 21, 23, 25 and 27 may be used. As such, the buffer index is moved back 5 addresses to address ‘1’. The I-frame is stored at address ‘1’.

Upon decoding the successive I-frames, the address is moved forward, and the P-frames 21, 23, 25 and 27 are stored at address ‘2’ to address ‘5’ and the address from ‘1’ to ‘5’ are marked as “in use”. The flag is set indicating the availability of the GOP ‘C’ for display. The decoded GOP ‘C’ upon being stored is displayed in the reverse playback. Further, as each frame of the GOP ‘C’ is displayed, the address corresponding to each frame is marked as “not in use”.

Simultaneously, the I-frame from the GOP ‘B’ preceding the I-frame of the first GOP is simultaneously identified during the playing of the GOP ‘C’. For storing the I-frame the buffer index is moved back five addresses of the circular buffer queue. However, only address ‘0’ is marked as “not in use”. As such, the decoding waits for the threshold number of frames to be played before resuming the decoding process.

In some embodiments, the method for reverse playback can be extended to live streaming of multimedia content over a network. In such a scenario, the server 115 may be used to perform steps 410 to 450. The electronic device 105 can be used to send the request for the reverse playback of the encoded multimedia content. The method will include additional steps of re-encoding the multimedia content and transmitting the multimedia content to the electronic device 105, prior to streaming the frame sequence for a time interval effecting the reverse playback at the server 115. Steps 430 and 450 can be replaced with steps of re-encoding the multimedia content and transmitting the multimedia content to the electronic device 105.

It is clear that the inventive method and apparatus for reverse playback of encoded multimedia content may be implemented in a form of hardware, soft ware (i.e., a program) or a combination thereof. Such a program may be stored in a volatile or non-volatile recording medium readable by a machine, such as a computer, wherein such a recording medium may be a storage device, such as a ROM, a memory, such as a RAM, a memory chip or an integrated circuit, or an optical or magnetic recording medium, such as a Compact Disc (CD), a Digital Video Disc (DVD), a magnetic disc or a magnetic tape. That is, the inventive method and apparatus for reverse playback of encoded multimedia content may be embodied in the form of programs including codes for realizing the inventive method and apparatus. Moreover, the programs can be electronically transferred through optional media such as communication signals that are transmitted through wires or wirelessly.

It will be apparent to a person of ordinary skill in the art that various modifications and changes can be made, without departing from the scope of the present disclosure, as set forth in the claims below. Accordingly, the specification and figures are to be regarded as illustrative examples of the present disclosure, rather than in restrictive sense. All such possible modifications are intended to be included within the scope of the present disclosure.

What is claimed is:

1. A method for reverse playback of encoded multimedia content, the method comprising:
receiving a request for the reverse playback of the encoded multimedia content from a user or an electronic device;
identifying a first Intra frame (I-frame) preceding a last played frame at an instant of receiving the request from a first Group Of Pictures (GOP) constituting a portion of the encoded multimedia content;
decoding first successive frames in the first GOP starting from the first I-frame;
storing the first decoded frames in a memory; and
playing the first decoded frames in a frame sequence effecting the reverse playback.

2. The method of claim 1, further comprising:
computing a total number of the first successive frames to be decoded from the first I-frame based on at least one of an available memory, a frame rate for playback, playback speed, a total number of frames to be displayed, and a ratio of the total number of frames to the playback speed.

3. The method of claim 1, further comprising:
identifying a second I-frame from a second GOP preceding the first I-frame and the first GOP during the playing of the one or more first decoded frames, wherein the second GOP constitute another portion of the encoded multimedia content;
decoding second successive frames in the second GOP;
storing the second decoded frames in the memory; and
playing the second decoded frames in a frame sequence effecting the reverse playback.

4. The method of claim 3, wherein the storing of the second decoded frames is suspended until a threshold number of the first decoded frames is played.

5. The method of claim 3, wherein the second successive frames are a part of the entire frames in the second GOP which are periodically disposed at regular intervals.

6. The method of claim 1, further comprising:
re-encoding the first decoded frames; and
transmitting the first encoded frames to the electronic device.

7. An apparatus for reverse playback of encoded multimedia content, the apparatus comprising:
a processor for identifying a first intra frame (I-frame) preceding a last played frame from a first group of pictures (GOP) constituting a first portion of the encoded multimedia content, at an instant of receiving a request for the reverse playback from a user or an electronic device, decoding first successive frames in the first GOP starting from the first I-frame, and playing the first decoded frames in a frame sequence effecting the reverse playback; and
a memory for storing the first decoded frames.

8. The apparatus of claim 7, further comprising:
a communication interface in electronic communication with a network.

9. A computer readable medium storing a program causing a processor to execute a process for data processing, the process comprising:
receiving a request for reverse playback of encoded multimedia content from a user or an electronic device;
identifying a first intra frame (I-frame) from a first group of pictures (GOP) preceding a last played frame at instant of receiving the request, wherein the first GOP constitute a portion of the encoded multimedia content;
decoding first successive frames in the first GOP starting from the first I-frame;
storing the first decoded frames in a memory; and
playing the first decoded frames in a frame sequence effecting the reverse playback.
